(19) United States
(12) Patent Application Publication
(10) Pub. No.: US 2011/0050561 A1
(43) Pub. Date: Mar. 3, 2011

(54) Color Electrophoretic Display and Display Method Thereof

(75) Inventors: Su-Cheng Liu, Hsinchu (TW); Ted-Hong Shinn, Hsinchu (TW); Sung-Kon Kim, Hsinchu (TW); Chun-Wei Hsieh, Hsinchu (TW)

(73) Assignee: Prime View International Co., Ltd.

(21) Appl. No.: 12/699,052

(22) Filed: Feb. 3, 2010

(30) Foreign Application Priority Data
Sep. 3, 2009 (TW) 098129762

(51) Int. Cl. G09G 3/34

(52) U.S. Cl. 345/107

(57) ABSTRACT

A color electrophoretic display and a display method thereof are provided. First, three primary color display data is generated according to a color image data, and whether or not to display a color image is determined. When it is determined not to display the color image, the three primary color display data is converted into gray display data according to a gray gamut look up table to display a gray picture on the electrophoretic display. When it is determined to display the color image, the color gamut of the three primary color display data is adjusted according to a color gamut look up table to display a color picture on the electrophoretic display.

This application claims the priority benefit of Taiwan application serial no.098129762, filed on Sep. 3, 2009.

### BACKGROUND

1. Field of the Invention

The present invention generally relates to a color electrophoretic display and a display method thereof and, more particularly, to a color electrophoretic display which can display both a gray picture and a color picture, and a display method thereof.

2. Description of Prior Art

Since the electrophoretic display has advantages such as low energy consumption and high contrast, the electrophoretic display becomes an important flat panel display and is more and more widely used in a variety of displays.

The electrophoretic display displays a picture by controlling the charged pigment particles in the electrophoretic fluid of each pixel to move. Particularly, a gray electrophoretic display controls the charged pigment particles of two different colors to move for controlling the reflection and absorption of light, so as to display a gray picture. In addition, a color electrophoretic display is formed by adding a color filter to a gray electrophoretic display, so that the color electrophoretic display can display a color picture. However, the current electrophoretic displays do not have the capability of displaying both a gray picture and a color picture. Thus, the application field of the electrophoretic display is limited.

### BRIEF SUMMARY

The present invention relates to a display method for a color electrophoretic display. The color electrophoretic display adopting the display method can display both a gray picture and a color picture.

The present invention relates to a color electrophoretic display adopting the aforementioned display method.

A preferred embodiment of the present invention provides a display method for a color electrophoretic display. The display method comprises the following steps: (a) generating three primary color display data according to a color image data, and determining whether or not to display a color image; (b) converting the three primary color display data into gray display data according to a gray gamut look up table to display a gray picture on the electrophoretic display when it is determined not to display the color image; and (c) adjusting the color gamut of the three primary color display data according to a color gamut look up table to display a color picture on the electrophoretic display when it is determined to display the color image.

A preferred embodiment of the present invention provides a color electrophoretic display. The color electrophoretic display comprises an electrophoretic display panel and a timing controller. The electrophoretic display panel includes a plurality of pixels. The timing controller has a gray gamut look up table and a color gamut look up table. Wherein, the timing controller generates three primary color display data according to a color image data, and the timing controller determines whether the color electrophoretic display is going to display a color image. When it is determined that the color electrophoretic display is not going to display a color image, the timing controller converts the three primary color display data into gray display data according to the gray gamut look up table to display a gray picture on the electrophoretic display. When it is determined that the color electrophoretic display is going to display a color image, the timing controller adjusts the color gamut of the three primary color display data according to the color gamut look up table to display a color picture on the electrophoretic display.

In an exemplary embodiment, each pixel of the color electrophoretic display includes four sub-pixels including a red sub-pixel, a green sub-pixel, a blue sub-pixel and a white sub-pixel. The four sub-pixels are electrically connected to two adjacent gate lines respectively. The two adjacent gate lines corresponding to the same pixel are driven synchronously when a gray picture is displayed by the color electrophoretic display. In addition, the two adjacent gate lines corresponding to the same pixel are driven in sequence when a color picture is displayed by the color electrophoretic display.

To sum up, the color electrophoretic display of the present invention generates three primary color display data according to a color image data and determines whether or not to display a color image. When it is determined not to display the color image, the three primary color display data is converted into gray display data according to a predetermined gray gamut look up table, so that the color electrophoretic display can display a gray picture. When it is determined to display the color image, the color gamut of the three primary color display data is adjusted according to a predetermined color gamut look up table, so that the color electrophoretic display can display a color picture. With this display method, the color electrophoretic display can display both a gray picture and a color picture. Thus, the application field of the color electrophoretic display is extended.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a color electrophoretic display in accordance with an exemplary embodiment of the present invention;

FIG. 2 is a diagram illustrating the timing sequence of the gate pulses adopted in the present invention;

FIG. 3 is a diagram illustrating another timing sequence of the gate pulses adopted in the present invention; and

FIG. 4 is a flow chart of a display method in accordance with an exemplary embodiment of the present invention.

### DETAILED DESCRIPTION

### First Embodiment

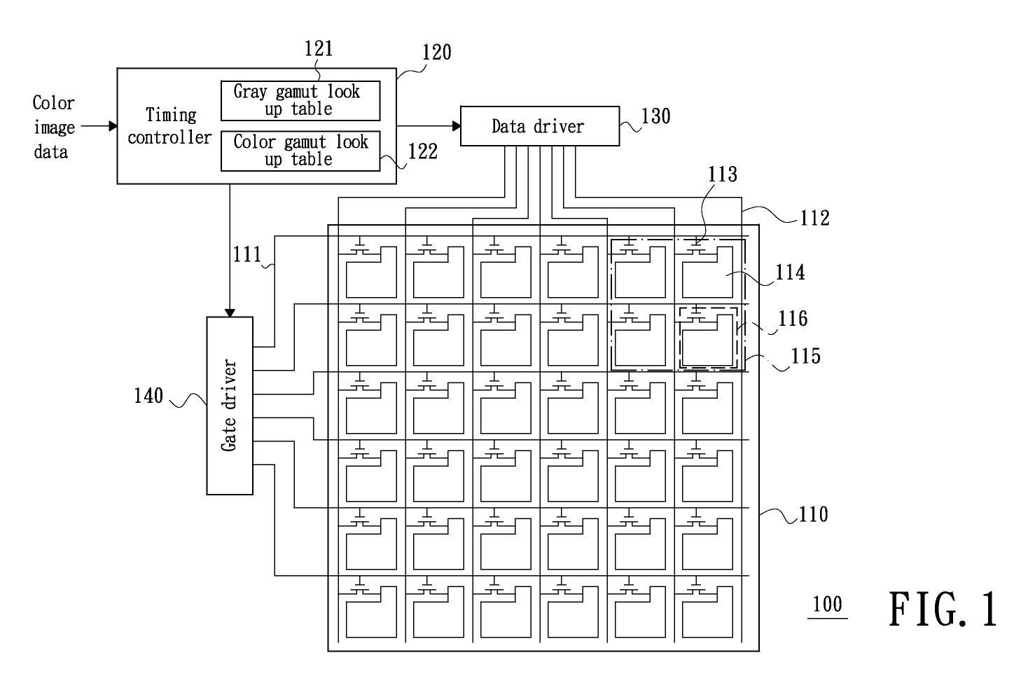

FIG. 1 is a schematic view of a color electrophoretic display in accordance with an exemplary embodiment of the present invention. In FIG. 1, the color electrophoretic display 100 includes an electrophoretic display panel 110, a timing controller 120, a data driver 130 and a gate driver 140. The data driver 130 and the gate driver 140 are both electrically connected to the electrophoretic display panel 110. In addition, the timing controller 120 is electrically connected to the data driver 130 and the gate driver 140, so as to control the electrophoretic display panel 110 via the data driver 130 and the gate driver 140 to display an image. The timing controller 120 has a gray gamut look up table 121 and a color gamut look up table 122. Hereinafter, the functions of the two tables will be described in detail.

The electrophoretic display panel 110 includes a plurality of pixels 115, and each of the pixels 115 includes four sub-pixels 116. The four sub-pixels 116 of each pixel 115 are respectively used for displaying four different colors. In this embodiment, the four sub-pixels 116 are respectively used for displaying red, green, blue and white. That is, each of the pixels 115 includes a red sub-pixel, a green sub-pixel, a blue sub-pixel and a white sub-pixel. Each of the sub-pixels 116 includes a transistor 113 and a pixel electrode 114. Furthermore, each of the sub-pixels 116 is electrically connected to the gate driver 140 through a gate line 111 and is electrically connected to the data driver 130 through a data line 112. From the configuration of the sub-pixels illustrated in FIG. 1, it can be seen that the four sub-pixels of each pixel 115 are electrically connected to two adjacent gate lines 111 respectively.

The operating manner of the color electrophoretic display 100 will be described in the following. After receiving a color image data, the timing controller 120 generates three primary color display data according to the received color image data. That is, the timing controller 120 generates red display data, green display data and blue display data. At the same time, the timing controller 120 also determines whether the color electrophoretic display 100 is going to display a color picture.

When it is determined that the color electrophoretic display 100 is not going to display a color picture, the timing controller 120 converts the three primary color display data into gray display data according to the gray gamut look up table 121. That is, the timing controller 120 converts the three primary color display data into the display data needed by the sub-pixels 116 to display a gray picture. Since the four sub-pixels of each pixel 115 are electrically connected to two adjacent gate lines 111 respectively, the timing controller 120 may arrange the obtained gray display data according to the sub-pixels configuration, so that the timing controller 120 may control the data driver 130 to provide the correct gray display data to the corresponding sub-pixels 116 according to the arranged data sequence.

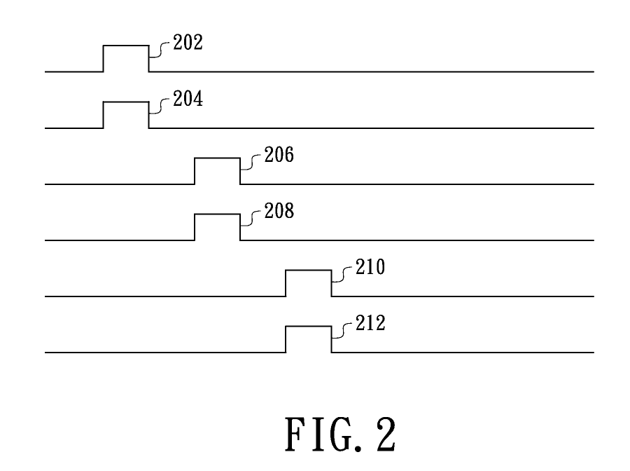

In addition, since the four sub-pixels of each pixel 115 are electrically connected to two adjacent gate lines 111 respectively and the sub-pixels of the same pixel may synchronously operate to load the corresponding gray display data for more accurately mix the light when a gray picture is displayed, the timing controller 120 may control the gate driver 140 to output gate pulses according to the timing sequence of the gate pulses illustrated in FIG. 2, so as to enable all the sub-pixels of the same pixel to operate synchronously. As illustrated in FIG. 2, the gate pulses 202 and 204 are respectively used for driving two adjacent gate lines of the same pixel, so that the sub-pixels connected to the aforementioned two gate lines may operate synchronously during the pulse enabling periods of the gate pulses 202 and 204. Similarly, the function of the gate pulses 206 and 208 and the function of the gate pulses 210 and 212 are both the same as that of the gate pulses 202 and 204. Thus, the electrophoretic display panel 110 can display the required gray picture.

Referring to FIG. 1, when it is determined that the color electrophoretic display 100 is going to display a color picture, the timing controller 120 adjusts the color gamut (i.e., adjusts the color saturation, wherein the said color saturation is the degree of the saturation of color) of the three primary color display data according to the color gamut look up table 122 and generates display data required by the white sub-pixels according to the color gamut look up table 122 and the three primary color display data. Since the four sub-pixels of each pixel 115 are electrically connected to two adjacent gate lines 111 respectively, the timing controller 120 may arrange the adjusted three primary color display data and the obtained display data of the white sub-pixels according to the sub-pixel configuration, so as to control the data driver 130 to output the correct display data to the corresponding sub-pixels 116 according to the arranged data sequence.

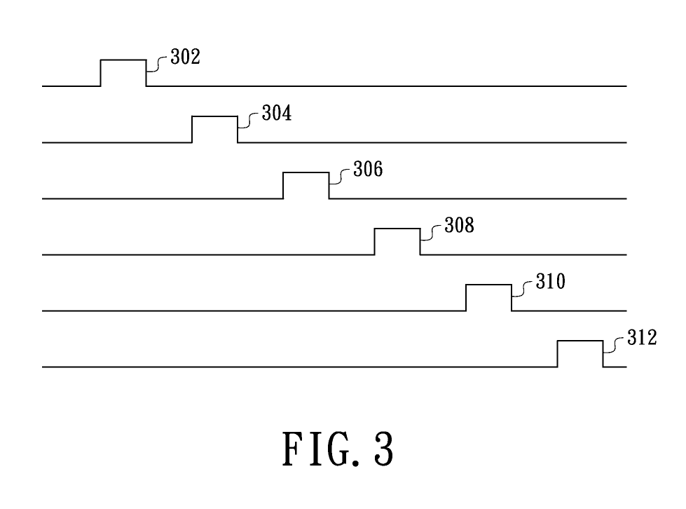

In addition, since the color electrophoretic display 100 needs not to display any gray picture, the timing controller 120 merely needs to control the gate driver 140 to output gate pulses according to the conventional timing sequence of the gate pulses, and this will be further described with reference to FIG. 3 as follows. As illustrated in FIG. 3, the gate pulses 302 and 304 are respectively used for driving two adjacent gate lines corresponding to the same pixel. Since the pulse enabling periods of the two gate pulses do not overlap to each other, the driving periods of the two gate lines do not overlap each other. Similarly, the function of the gate pulses 306 and 308 and the function of the gate pulses 310 and 312 are both the same as those of the gate pulses 302 and 304. From FIG. 3, it can be understood that the gate driver 140 merely needs to drive the two adjacent gate lines corresponding to the same pixel in sequence when a color picture is displayed. Thus, the electrophoretic display panel 110 can display the required color picture.

### Second Embodiment

Based on the teaching of the first embodiment, a person with ordinary skill in the art may easily conclude that the present invention can also be implemented when each pixel only includes a red sub-pixel, a green sub-pixel and a blue sub-pixel and without any white sub-pixels. Therefore, in this embodiment, each pixel of the color electrophoretic display only includes a red sub-pixel, a green sub-pixel and a blue sub-pixel, and the color electrophoretic display operates by such sub-pixel configuration. It should be pointed out that regardless of the color electrophoretic display in this embodiment displays a gray picture or a color picture, the timing controller need not generate the display data required by the white sub-pixels according to a gray gamut look up table or a color gamut look up table. That is, the timing controller merely needs to process the display data required by the red sub-pixels, the green sub-pixels and the blue sub-pixels. In other words, the timing controller merely needs to arrange the display data according to the actual configuration of the sub-pixels.

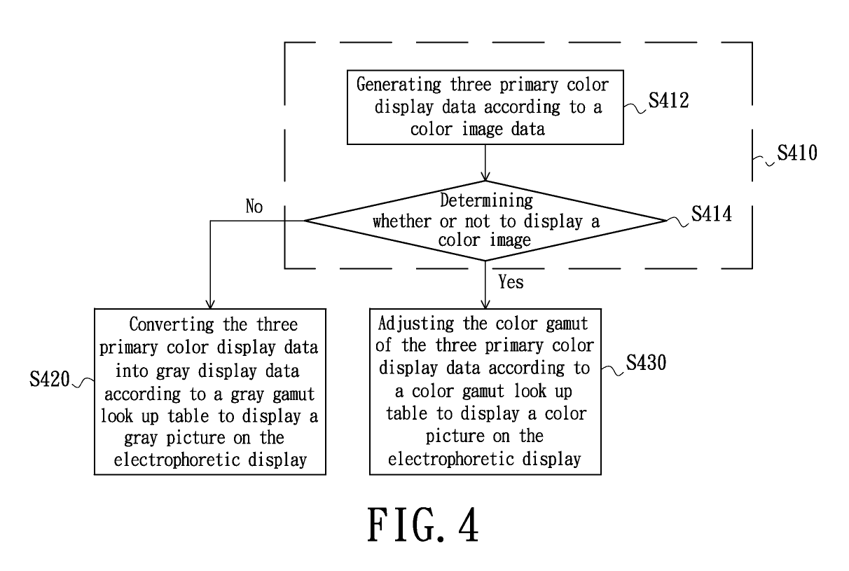

Based on the above embodiments, a basic operating process can be induced, and this will be further described with reference to FIG. 4 as follows. FIG. 4 is a flow chart of a display method in accordance with an exemplary embodiment of the present invention. The display method can be applied to a color electrophoretic display. The method comprises: generating three primary color display data according to a color image data and determining whether or not to display a color image (step S410); converting the three primary color display data into gray display data according to a gray gamut look up table to display a gray picture on the electrophoretic display (step S420) when it is determined not to display the color image in step S410, and then proceed to step S420; and adjusting the color gamut of the three primary color display data according to a color gamut look up table to display a color picture on the electrophoretic display (step S430) when it is determined to display the color image in step S410. Wherein, the step S410 is divided into two sub-steps, and the two sub-steps are illustrated by the executing step S412 and the determining step S414 of FIG. 4.

To sum up, the color electrophoretic display of the present invention generates three primary color display data according to a color image data and determines whether to display a color image. When it is determined not to display the color image, the three primary color display data is converted into gray display data according to a predetermined gray gamut look up table, so that the color electrophoretic display may display a gray picture. When it is determined to display the color image, the color gamut of the three primary color display data is adjusted according to a predetermined color gamut look up table, so that the color electrophoretic display may display a color picture. With this display method, the color electrophoretic display can display both a gray picture and a color picture. Thus, the application field of the color electrophoretic display is extended.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A display method for a color electrophoretic display, comprising the following steps:
(a) generating three primary color display data according to a color image data, and determining whether to display a color image;
(b) converting the three primary color display data into gray display data according to a gray gamut look up table to display a gray picture on the electrophoretic display when it is determined not to display the color image; and
(c) adjusting the color gamut of the three primary color display data according to a color gamut look up table to display a color picture on the electrophoretic display when it is determined to display the color image.

2. The display method as claimed in claim 1, wherein the three primary color display data includes red display data, green display data and blue display data.

3. The display method as claimed in claim 1, wherein the step (b) further comprises:
arranging the gray display data according to an actual configuration of sub-pixels of the color electrophoretic display to provide the arranged gray display data to corresponding sub-pixels.

4. The display method as claimed in claim 3, wherein each pixel of the color electrophoretic display includes four sub-pixels which are electrically connected to two adjacent gate lines respectively, when the gray picture is displayed, the two adjacent gate lines corresponding to the same pixel are driven synchronously.

5. The display method as claimed in claim 1, wherein the step (c) further comprises:
arranging the adjusted three primary color display data according to the actual configuration of the sub-pixels of the color electrophoretic display to provide the adjusted three primary color display data to the corresponding sub-pixels.

6. The display method as claimed in claim 1, wherein each pixel of the color electrophoretic display includes four sub-pixels including a red sub-pixel, a green sub-pixel, a blue sub-pixel and a white sub-pixel, the four sub-pixels are electrically connected to two adjacent gate lines respectively, and the step (c) further comprises:
generating a display data of the white sub-pixel according to the color gamut look up table and the three primary color display data.

7. The display method as claimed in claim 6, wherein the step (c) further comprises:
arranging the adjusted three primary color display data and the display data of the white sub-pixel according to the actual configuration of the sub-pixels of the color electrophoretic display to provide the arranged display data to the corresponding sub-pixels.

8. The display method as claimed in claim 7, wherein when the color picture is displayed, the two adjacent gate lines corresponding to the same pixel are driven in sequence.

9. A color electrophoretic display, comprising:
an electrophoretic display panel including a plurality of pixels; and
a timing controller having a gray gamut look up table and a color gamut look up table;
wherein the timing controller generates three primary color display data according to a color image data, and the timing controller determines whether or not the color electrophoretic display is going to display a color image, wherein when it is determined that the color electrophoretic display is not going to display a color image, the timing controller converts the three primary color display data into gray display data according to the gray gamut look up table to display a gray picture on the electrophoretic display, and when it is determined that the color electrophoretic display is going to display a color image, the timing controller adjusts the color gamut of the three primary color display data according to the color gamut look up table to display a color picture on the electrophoretic display.

10. The color electrophoretic display as claimed in claim 9, wherein each pixel of the color electrophoretic display includes four sub-pixels which are electrically connected to two adjacent gate lines respectively.

11. The color electrophoretic display as claimed in claim 10, wherein the four sub-pixels includes a red sub-pixel, a green sub-pixel, a blue sub-pixel and a white sub-pixel.

12. The color electrophoretic display as claimed in claim 11, wherein the two adjacent gate lines corresponding to the same pixel are driven synchronously when the gray picture is displayed by the color electrophoretic display.

13. The color electrophoretic display as claimed in claim 11, wherein the two adjacent gate lines corresponding to the same pixel are driven in sequence when the color picture is displayed by the color electrophoretic display.
